(19) United States
(12) Patent Application Publication
(10) Pub. No.: US 2010/0258376 A1
(43) Pub. Date: Oct. 14, 2010

(54) Device to prevent noise in ladder rung assemblies

(76) Inventor: Mark W. Ward, Evansville, IN (US)

Correspondence Address: Thomas Heed, 1732 Chicory Ridge, Ann Arbor, MI, 48103, US

(21) Appl. No.: 12/798,651

(22) Filed: Apr. 8, 2010

Related U.S. Application Data
(60) Provisional application No. 61/168,967, filed on Apr. 14, 2009.

(51) Int. Cl. G10K 11/16

(52) U.S. Cl. 181/175

(57) ABSTRACT

The invention is a device intended to be inserted into the hollow rungs of a ladder. The purpose of the invention is to prevent the rungs from having tube resonances during transport.

This is a non-provisional utility patent application of a provisional patent application 61/168,967, filed 14 Apr. 2009.

### BACKGROUND OF INVENTION

This invention relates to tools and equipment, specifically to ladders.

This invention is designed to reduce wind-noise caused by tube-resonances when moving ladders from location to location. In their simplest embodiment, ladders are created by stringers (vertical) and rungs (horizontal). Most ladders, today, are constructed from aluminum, fiber composites, or other light-weight materials. The rungs are made of hollow tubes with a flattened circular profile, open where they are fused with the stringer. Many skilled laborers move ladders from job-site to job-site by lashing the ladder to the top or sides of a vehicle. When the vehicle is in motion, air rushing past the hollow rungs, creates tube resonances. The tube resonances have been described, inter alia, as howling, humming, vibrating, and whistling. Regardless of the words used to descried it, the noise made by air rushing over the rungs while the ladder is being transported is highly objectionable.

Skilled laborers and other practitioners have attempted to solve this problem, themselves. The most prevalent method for solving this problem is to inject expand-in-place foam products into the tube openings. This method has several significant drawbacks. First, most of the expand-in-place foam products rapidly degrade when exposed to the elements. Typically, the expand-in-place foam product will crack and crumble within a few months. However, a foam residue will remain bonded to the inside of the rung. Subsequent re-applications of expand-in-place foam last for even shorter durations due to the residue. Eventually, the openings of the tube are an unsightly mess, which still howl, whistle, and vibrate.

### SUMMARY OF THE INVENTION

The present invention is a device designed to durably plug the hollow rungs of ladders to prevent tube resonances. The device is a sponge-like material, in that it is, at least initially, reversibly compressible or irreversibly expandable, allowing it to be inserted into the opening of a hollow ladder rung.

The invention may best be understood by referring to the description of the drawing and invention.

### BRIEF DESCRIPTION OF THE DRAWINGS

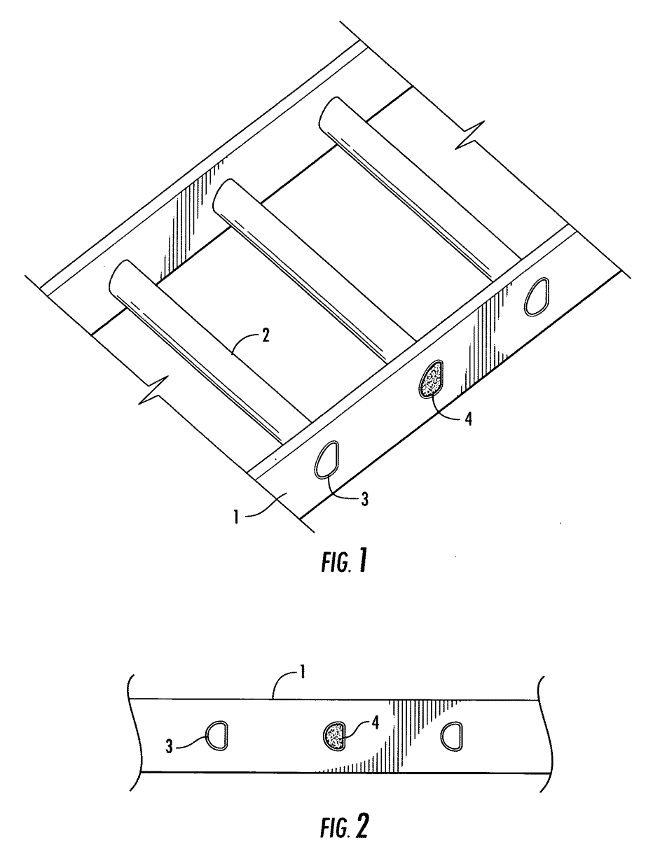

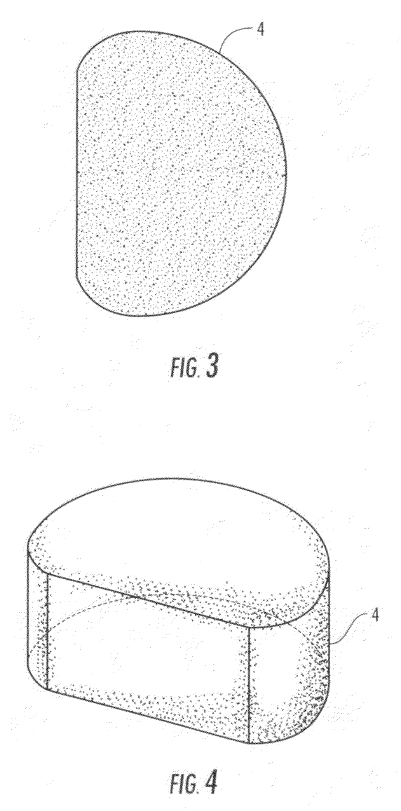

There are four relevant drawings. FIG. 1 is a perspective view of a typical ladder, with the invention in situ. FIG. 2 is a lateral side view of a typical ladder, with the invention in situ. FIG. 3 is a top view of the invention without reference to a ladder. FIG. 4 is a perspective 3-D view of the invention without reference to a ladder.

### DETAILED DESCRIPTION OF INVENTION

The following description represents the inventor's current preferred embodiment. The description is not meant to limit the invention, but rather to illustrate its general principles of operation and construction.

A typical ladder is constructed from stringers (1) and rungs (2). Stringers (1) must come in pairs. Rungs (2) are spaced anywhere from 6″ to 18″ apart, with spacing in the 8″ to 14″ range being most common. Stringers (1) are made of solid material, usually metal, such as aluminum. Rungs (2) are usually made of tube aluminum or equivalent material. Usually, rungs (2) have a flattened circular profile, to make stepping on them easier. Rungs (2) are made of hollow tubing in order to create a strong, light-weight step. The rungs (2) can be bonded to the stringer (1) by welding, brazing, press-fitting, or mechanically connecting using folded metal.

Ladders are used by a wide variety of professions: painters, home-builders, carpenters, gutter fabricators, gardeners, construction workers, glazier, electricians, etc. These and many other professions move ladders from job-site to job-site.

When a ladder is moved from one job-site to another, it is often lashed to the exterior of a vehicle. When the ladder is lashed to a moving vehicle, air passing over the hollow opening of the rung (3) excites resonance modes in the hollow tubes of the rungs (3). The resonance is experienced by the driver and passengers of the vehicle as a loud noise variously described as howling, humming, vibrating, oscillating, warbling, buzzing, among other descriptions. The noise is highly objectionable.

The present invention stops this noise by blocking the hole in the tube (4). The present invention is a piece of sponge-like material, which can be temporarily or permanently inserted into the rung (2) opening (3). The material is sponge-like in that it is, at least initially, reversibly compressible or irreversibly expandable, in order to be inserted into the opening (3). The invention can be fabricated from foam rubber, closed-cell foam, open-cell foam, thermo-plastic elastomers, nitrile rubber, butyl rubber, and expand-in-place materials.

The best mode uses a closed-cell rubber piece inserted, as a stopper or bung, into each end of the ladder rung (4). The preferred material is a Neoprene® sponge rubber. In any embodiment, the invention has to be environmentally stable in order to serve its purpose. For both open- and closed-cell foam, this requires that the foam be UV protected. For expand-in-place materials, it must be UV protected and bondable to the ladder substrate. For thermo-plastic elastomers, it must be dimensionally stable at 150° F., the maximum surfaces temperature of an aluminum ladder left sitting outside in the sunshine on a hot day.

FIG. 3 shows the invention, top view, in its uncompressed and unexpanded state (5). In this embodiment, the invention has a flattened, circular profile to fit into a rung with a corresponding, flattened, circular profile. The invention may be made with any profile, so that it can be inserted into a rung hole (3) with any profile. FIG. 4 shows the invention, in profile, in its uncompressed and unexpanded state (6). The dimensions of the invention (5 and 6) may change in order to fit into various sized rung holes (4). In any event, the device dimensions must be large enough in comparison with the internal rung dimensions, so that the normal force between the device and the inside of the rung causes the device to remain in place.

To use the best mode invention, a user would compress the piece slightly and press it into place in the rung hole (3). The invention should be more or less uniformly compressed until it bottom edge fits in the rung hole (3). The invention is then pressed on the top until it is completely inserted in the rung hole (3). Once in place, the force-fit nature of the invention keeps it in place (4).

The preceding discussion exemplifies the best mode of this invention. It is not meant to limit the scope of the invention, as revealed in the following claim.

We claim:

1. A device designed to reduce or eliminate noise caused by air rushing over and through the rungs of a ladder, comprising a piece of material, which is at least originally compressible or subsequently expandable, allowing it to be inserted into the end of a ladder rung to block the rung opening, and which will remain in place due to the mechanical fit between the device and the inside of the rung hole.
